(19) United States
(12) Patent Application Publication
(10) Pub. No.: US 2026/0137029 A1
(43) Pub. Date: May 21, 2026

(54) AGRICULTURAL HARVESTING SYSTEMS AND RELATED DEVICES AND METHODS

(71) Applicant: Ag Leader Technology, Ames, IA (US)

(72) Inventors: Aaron Friedlein, Farmersburg, IA (US); Roger Zielke, Huxley, IA (US)

(21) Appl. No.: 19/396,047

(22) Filed: Nov. 20, 2025

Related U.S. Application Data
(60) Provisional application No. 63/722,916, filed on Nov. 20, 2024.

(51) Int. Cl. A01D 41/127; A01C 21/00

(52) U.S. Cl. CPC A01D 41/1277; A01C 21/005; A01D 41/1272

(57) ABSTRACT

An agricultural harvester comprising a plurality of rows divided by a plurality of snoots, a least one camera disposed on each of the plurality of snoots positioned such as to view gathering chains of each of the plurality of rows, a processor in communication with the at least one camera, wherein the processor is configured to determine fruit production per stalk, fruit size, kernel number per ear, loose kernels, and weed number.

### CROSS-REFERENCE TO RELATED APPLICATION(S)

This application claims the benefit under 35 U.S.C. § 119(e) to U.S. Provisional Application 63/722,916, filed Nov. 20, 2024, and entitled Agricultural Harvesting Systems and Related Devices and Methods, which is hereby incorporated herein by reference in its entirety for all purposes.

### TECHNICAL FIELD

The disclosure relates to agricultural harvesting, data visualization, and enterprise control.

### BACKGROUND

For various agricultural stakeholders (growers, crop advisors, agronomists, etc.) crop information from prior years may be used to make decisions about subsequent plantings and operations. Crop information and observations may include growing season observations (e.g., weather), plant roots, fruit characteristics, yield, and others.

### BRIEF SUMMARY OF THE INVENTION

Disclosed herein are methods and related systems and devices for collecting various pieces of information at the time of harvest to make certain observations about crops. The devices, systems, and methods may then analyze and process the data and observations to give recommendations to stakeholders and/or to take automatic actions. In various of the systems, methods, and devices disclosed herein a camera is mounted on the harvester in a location that provides a view of the crop as it is harvested.

In Example 1, an agricultural harvester comprising a plurality of row units divided by a plurality of

snoots, at least one camera disposed on each of the plurality of snoots positioned such as to view gathering chains the plurality of row units, and a processor in communication with the at least one camera, wherein the processor is configured to determine one or more of fruit production per stalk, fruit size, kernel number per ear, loose kernels, shelling events, and weed number.

Example 2 relates to the agricultural harvester of any of Examples 1 and 3-7, wherein the at least one camera is integral with a respective one of the plurality of snoots.

Example 3 relates to the agricultural harvester of any of Examples 1-2 and 4-7, further comprising at least one stalk sensor disposed on each of the plurality of row units configured to detect plant stalks, the at least one stalk sensor in communication with the processor, wherein the processor is configured to correlate imagery from the at least one camera with data from the at least one stalk sensor.

Example 4 relates to the agricultural harvester of any of Examples 1-3 and 5-7, wherein the processor is configured to determine a number of kernels per ear based on imagery from the least one camera.

Example 5 relates to the agricultural harvester of any of Examples 1-4 and 6-7, wherein the number of kernels per ear is based upon a detected number of rows on the ear and the length of kernels on the ear.

Example 6 relates to the agricultural harvester of any of Examples 1-5 and 7, wherein the processor is configured to detect and determine a number of unpollinated kernels, aborted kernels, and normal kernels.

Example 7 relates to the agricultural harvester of any of Examples 1-6, wherein the processor is configured to adjust a planting and growing prescription based on the detected a number of unpollinated kernels, aborted kernels, and normal kernels.

In Example 8, a harvesting system comprising a plurality of cameras disposed on a corn head oriented to view gathering chains of the corn head row units and configured to gather imagery of plants during harvest operations and a processor in communication with the plurality of cameras configured to analyze the gathered imagery.

Example 9 relates to the harvesting system of any of Examples 8 and 10-15, wherein the processor is configured to detect a shelled ear event by estimating a number of loose kernels present and when the number of loose kernels exceeds a threshold value a shelled ear event is detect, and wherein the processor is configured to automatically adjust one or more header settings in response to a detected shelled ear event.

Example 10 relates to the harvesting system of any of Examples 8-9 and 11-15, wherein the processor is configured to detect and enumerate a number of unpollinated ears, aborted kernels, and normal kernels harvested.

Example 11 relates to the harvesting system of any of Examples 8-10 and 12-15, wherein if the number of unpollinated ears or aborted kernels exceeds a threshold value the processor may automatically adjust a planting prescription for a future planting to adjust a population to be planted or adjust an amount of fertilizer to be applied.

Example 12 relates to the harvesting system of any of Examples 8-11 and 13-15, further comprising a memory in communication with the processor, the memory storing weather data from a growing season, and wherein the weather data may be analyzed along with the imagery to assess plant health.

Example 13 relates to the harvesting system of any of Examples 8-12 and 14-15, wherein the plurality of cameras are integral with their respective snoot.

Example 14 relates to the harvesting system of any of Examples 8-13 and 15, wherein the plurality of cameras are mounted on a first side of a plurality of snoots dividing a plurality of row units.

Example 15 relates to the harvesting system of any of Examples 8-14, further comprising at least one stalk sensor disposed on each of the plurality of row units configured to detect plant stalks, the at least one stalk sensor in communication with the processor, wherein the processor is configured to correlate imagery from the plurality of cameras with data from the at least one stalk sensor.

In Example 16, a method for assessing harvest health comprising obtaining imagery from a plurality of cameras mounted on a corn head during harvest and orientated to view gathering chains of the corn head, processing the imagery to detect one or more indicators of harvest health including one or more of number of ears harvested, shelled ear events, number of unpollinated ears, number of aborted kernels, number of kernels per ear, number of normal kernels, weed presence, and disease presence, and outputting one or more recommendations or actions for modifying a planting prescription to improve yield based on the detected indicators of harvest health.

Example 17 relates to the method of any of Examples 16 and 18-20, further comprising detecting a shelled ear event by estimating a number of loose kernels present and when the number of loose kernels exceeds a threshold value a shelled ear event is detected, and adjusting one or more header settings in response to a detected shelled ear event.

Example 18 relates to the method of any of Examples 16-17 and 19-20, wherein the one or more recommendations or actions is adjusting a planting prescription for a future planting to adjust a population to be planted or adjust an amount of fertilizer to be applied

Example 19 relates to the method of any of Examples 16-18 and 20, further comprising sensing plant stalks with a crop sensor mounted on a row unit of the corn head.

Example 20 relates to the method of any of Examples 16-19, wherein the plurality of cameras are mounted on snoots of the corn head.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF DRAWINGS

FIG. 1 is a schematic diagram of the system implemented on a combine, according to one implementation.

FIG. 2 is a system diagram, according to one implementation.

FIG. 3 is a top view of a combine implementing the system, according to one implementation.

FIG. 4 is a cross-section view of a header, according to one implementation.

FIG. 5 is a top view of a combine, according to one implementation.

FIG. 6 is a top view of an exemplary crop sensor, according to one implementation.

FIG. 7 shows an example of a corn ear having loose kernels from a shelled ear event.

FIG. 8 shows an example of a corn ear having aborted kernels and unpollinated kernels/tip back.

FIG. 9 shows an example of a diseased corn ear.

### DETAILED DESCRIPTION

Disclosed herein are various devices, systems, and methods for making informed decisions with the use of data regarding planted and harvest stand counts, as well as other harvest metrics including fruit data (e.g., size, aborted kernels, unpollinated ears, disease status), weed data, and other data as will be discussed further herein. Growers, operators, and other stakeholders need accurate measures of how crops are performing in order to make and execute informed decisions and/or to allow various systems and devices to autonomously or semi-autonomous make and execute decisions for future plantings and operations.

As would be understood, different crops produce different kinds of fruit, and some of these fruits using the disclosed system may be captured by a camera in an image, picture, video frame, or the like as a harvest operation or scouting operation is occurring. From the captured imagery, the disclosed system may be able to determine various metrics such as the size of fruit, the number of fruit present/harvested, and other metrics as would be understood in the art and discussed herein. The system may also be able to determine how many plants harvested had fruit.

Use of the system may allow for users and/or the system to use expected versus actual yield, that is, the number of seed planted (expected yield) compared to the number of plants that were harvested (in the case of corn, having a harvestable ear) as a measure of crop performance.

As would be understood by those of skill in the art, in the case of corn, it is often the case that a late-emerged plant (a plant that emerged a few days after an adjacent plant) will produce a much smaller ear or even no ear at all. Knowledge of late emerged plants or plants not bearing fruit may allow a stakeholder or other autonomous system to determine a cause of the lost yield such as planter settings and/or field/soil conditions. This knowledge of the cause of the lost yield may allow for a stakeholder or autonomous system to make adjustments for future actions to improve yields.

Additionally, use of the disclosed system, methods, and devices may allow stakeholders to assess if strip trials in a field were beneficial for one treatment versus a different treatment. For example a stakeholder may observe that there are fewer ear producing plants than expected by using the disclosed system. In many cases, the knowledge may allow a stakeholder and/or autonomous system to take action to improve planter performance such as with seed placement, hydraulic downforce, use of alternative seed meters or other planter setting as would be understood.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. Pat. No. 12,353,210, issued Jul. 8, 2025, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. Pat. No. 11,877,530 issued Jan. 23, 2024, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. Pat. No. 12,268,115, issued Apr. 8, 2025, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. Pat. No. 12,414,505, issued Sep. 16, 2025, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/556,506, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. Pat. No. 12,403,950, issued Sep. 2, 2025, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,344, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. patent application Ser. No. 18/665,305, filed May 15, 2024, entitled “Devices, Systems, and Methods for Agricultural Guidance and Navigation,” U.S. patent application Ser. No. 18/761,041, filed Jul. 1, 2024, entitled “Ring Assembly For Automatic and/or Assisted Steering and Associated Systems and Methods,” U.S. patent application Ser. No. 18/766,374, filed Jul. 8, 2024, entitled “Assisted Steering Systems and Associated Devices and Methods for Agricultural Vehicles,” U.S. patent application Ser. No. 18/929,309, filed Oct. 28, 2024, entitled “Agricultural Implement Position Sensor and Related Devices, Systems, and Methods,” U.S. patent application Ser. No. 18/962,799, filed Nov. 27, 2024, entitled “Devices, Systems and Methods for Guidance Line Shifting,” U.S. patent application Ser. No. 18/974,482, filed Dec. 9, 2024, entitled “Header Height Control Devices, Systems and Methods,” U.S. patent application Ser. No. 18/980,728, filed Dec. 13, 2024, entitled “Deck Plate Spacing Sensors and Related Devices, Systems, and Methods,” U.S. patent application Ser. No. 19/041,787, filed Jan. 30, 2025, entitled “Grain Cart Unloading Sensor and Unload Control System and Associated Devices and Methods,” U.S. patent application Ser. No. 19/207,115, filed May 13, 2025, entitled “Devices, Systems, and Methods for Planter and Seed Trench Imaging and Analysis,” U.S. patent application Ser. No. 19/219,718, fled May 27, 2025, entitled “Devices, Systems, and Methods for Agricultural Navigation and Positioning,” U.S. patent application Ser. No. 19/226,004, filed Jun. 2, 2025, entitled “Devices, Systems, and Methods for Machinery Monitoring and Reporting,” U.S. Patent Application 63/667,546, filed Jul. 3, 2024, entitled “Cover for Port Openings,” U.S. patent application Ser. No. 19/260,159, filed Jul. 3, 2025, entitled “Agricultural Seed Meters and Related Devices, Systems and Methods,” U.S. patent application Ser. No. 19/297,963, filed Aug. 12, 2025, entitled “Agricultural Navigation and Steering Systems, Devices and Methods,” U.S. patent application Ser. No. 19/305,530, filed Aug. 20, 2025, entitled “Crop Sensor Wands and Related Devices, Systems, and Methods,” U.S. patent application Ser. No. 19/366,202, filed Oct. 22, 2025, entitled “Crop Sensors and Related Devices, Systems, and Methods,” U.S. patent application Ser. No. 19/367,363, filed Oct. 23, 2025, entitled “Agricultural Sprayer Sensor and Related Devices, Systems, and Methods,” U.S. patent application Ser. No. 19/390,280, filed Nov. 14, 2025, entitled “Liquid Product Distribution for Agricultural Spraying Systems and Related Devices and Methods,” U.S. Patent Application 63/723,400, filed Nov. 21, 2024, entitled “Systems, Methods and Devices for Increasing Machine Operating Range Using PWM and Dynamic Pressure Range Control,” U.S. Patent Application 63/727,579, filed Dec. 3, 2024, entitled “Smart Shift for Automatic AB Line Adjustment in Agricultural Operations and Related Devices and Methods,” U.S. Patent Application 63/752,279, filed Jan. 31, 2025, entitled “System and Automatic Adjustment to Target Pressure and Related Devices and Methods,” U.S. Patent Application 63/752,341, filed Jan. 31, 2025, entitled “Harvester Liquid Application System, Devices, and Methods,” U.S. Patent Application 63/753,258, filed Feb. 3, 2025, entitled “Agricultural Navigation Methods, Devices, and Systems,” U.S. Patent Application 63/753,201, filed Feb. 3, 2025, entitled “Agricultural Mapping and Related Devices, Systems, and Methods” U.S. Patent Application 63/755,675, filed Feb. 7, 2025, entitled “Remote Assistance for Agricultural Display Methods and Related Devices and Systems,” U.S. Patent Application 63/757,242, filed Feb. 11, 2025, entitled “Seed Meter,” U.S. Patent Application 63/757,434, filed Feb. 12, 2025, entitled “Grain Fill Sensor,” U.S. Patent Application 63/760,907, filed Feb. 20, 2025, entitled Agricultural Yield Monitoring and Estimation Devices, Systems, and Methods,” U.S. Patent Application 63/816,284, filed Jun. 2, 2025, entitled “Agricultural Guidance and Navigation Systems, Methods, and Devices,” U.S. Patent Application 63/817,692, filed Jun. 4, 2025, entitled “Intelligent Steering System for Sprayers and Tractors in Standing Crops,” U.S. Patent Application 63/818,248, filed Jun. 5, 2025, entitled “Devices, Systems, and Methods for Determining Implement Pose,” U.S. Patent Application 63/906,692, filed Oct. 28, 2025, entitled “Agricultural Alignment System and Related Devices and Methods,” and U.S. Patent Application 63,906,646, filed Oct. 28, 2025, entitled “Automated Grail Filling System and Related Devices and Methods,” each of which is incorporated herein by reference.

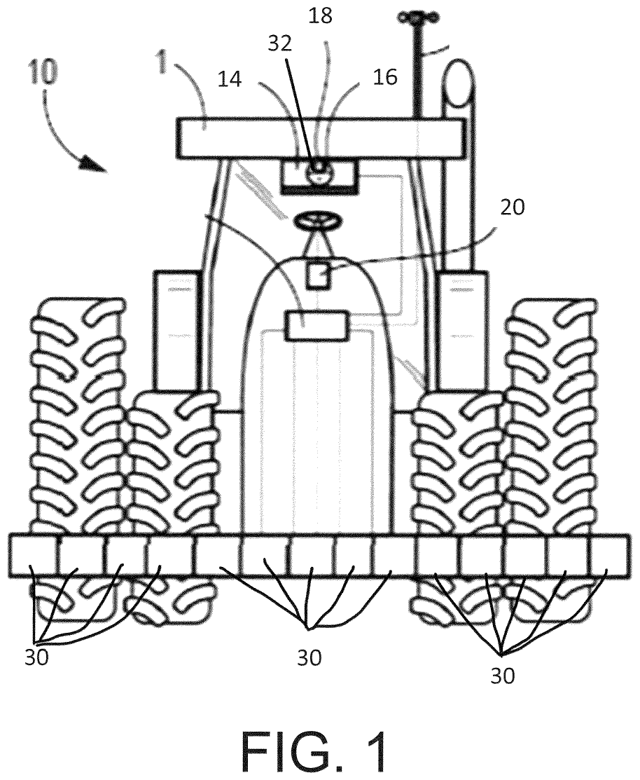

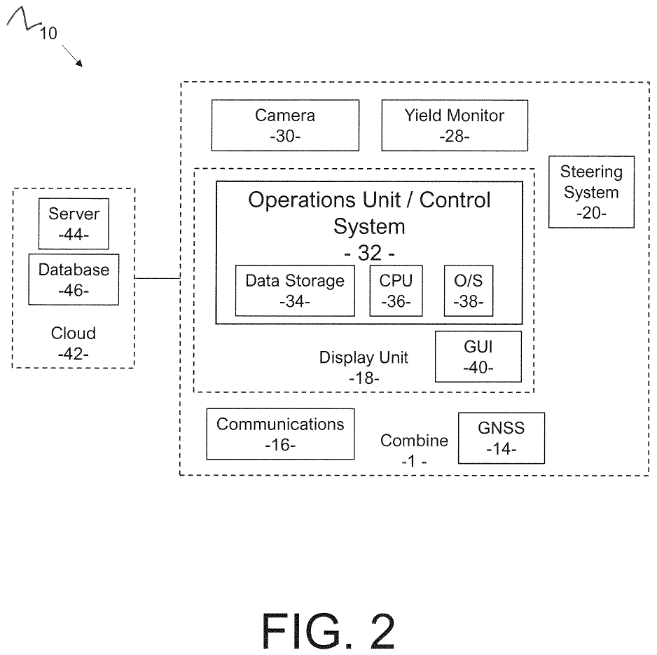

Turning now to the figures in more detail, in various implementations, the system 10 is implemented on a combine 1 or similar vehicle 1, as would be understood, shown in FIG. 1. In various implementations, the system 10 includes a GNSS or GPS receiver 14, one or more cameras 30 in operational communication with a vehicle system display 18, such as the InCommand® display from Ag Leader®, and an operations unit 32, as is shown in greater detail in FIG. 2. The system 10 optionally comprises various additional sensors, monitors and the like, as would be appreciated by those of skill in the art and as disclosed in various of the incorporated references. The system 10 further optionally includes an automatic and/or assisted steering system 20.

Continuing with FIGS. 1 and 2, in various implementations, the system 10, optionally integrated within the display 18, includes an operations unit 32 in operational communication with data link 16 (also referred to herein as a communications component 16). It is generally understood that these components may optionally be housed within the display unit 18 and that the representation of FIG. 2 is merely exemplary.

In certain implementations, the operations unit 32 is also configured for the sending and receiving of data for storage and processing, such as to the cloud 42, a remote server 44, database 46, and/or other computing components readily understood in the art. Such connections by the operations unit 32, can be made wirelessly via understood internet and/or cellular technologies such as Bluetooth, Wi-Fi, LTE, 3G, 4G, or 5G connections, and the like. It is understood that in certain implementations, the operations unit 32 and/or cloud 42 component may comprise encryption or other data privacy components such as hardware, software, and/or firmware security aspects.

Continuing with FIG. 2, the operations unit 32, according to certain implementations, has one or more optional processing and computing components, such as data storage 34, a CPU or processor 36, an operating system (“O/S”) 38, graphical user interface (“GUI”) 40, and other computing components necessary for implementing the various technologies disclosed herein. It would be appreciated that the various optional components are in operational communication with one another via wired or wireless connections and are configured to perform the processes and execute the commands described herein. As would be understood, each of these components can be located optionally at various locations around the vehicle or elsewhere, such as in the cloud 42 and accessible by a wireless or cellular connection.

In various implementations, this connectivity means that an operator, enterprise manager, and/or other third party can receive notifications such as adjustment prompts and confirmation screens on their mobile devices or via another access points. In certain implementations, these individuals can review the various data collected or recorded by the system 10 and make adjustments, comments, and/or observations in real-time or near real-time, as would be readily appreciated.

As shown in FIGS. 1 and 2, the system 10 includes at least one camera 30 that is in operational communication with the operations unit 32 via the communications component or data link 16.

As would be generally understood, as crops enter the corn head 50 the plant is pulled down quickly, and in the case of corn, the fruit (kernels) may be damaged where the fruit detaches from the stalk and can be lost on the ground. Previously, this action can be difficult for an operator to see. The described system 10 allows for visualization of this process and optional manual, semiautomatic, or automatic adjustment of header 50 settings such as height, to avoid this type of loss.

Additionally, as ears of corn are harvested the husk that surrounds the ear is stripped away exposing the whole ear. With the disclosed system 10, the camera 30 may capture a view of the ear to determine the number of kernels on a side of the ear, and optionally, the number of rows of kernels on the ear. The information may allow the system 10 to automatically or semi automatically determine yield, how the fruit grew, and other crop metrics, as will be described further herein.

Additionally, the system 10 may be configured to observe and detect if the fruit, such as corn ears, experienced stress while maturing. This can include detecting (1) kernels that were never pollinated; (2) kernels that were pollinated but due to a lack of nutrients or moisture were aborted by the plants; and/or (3) kernels that were pollinated and matured normally.

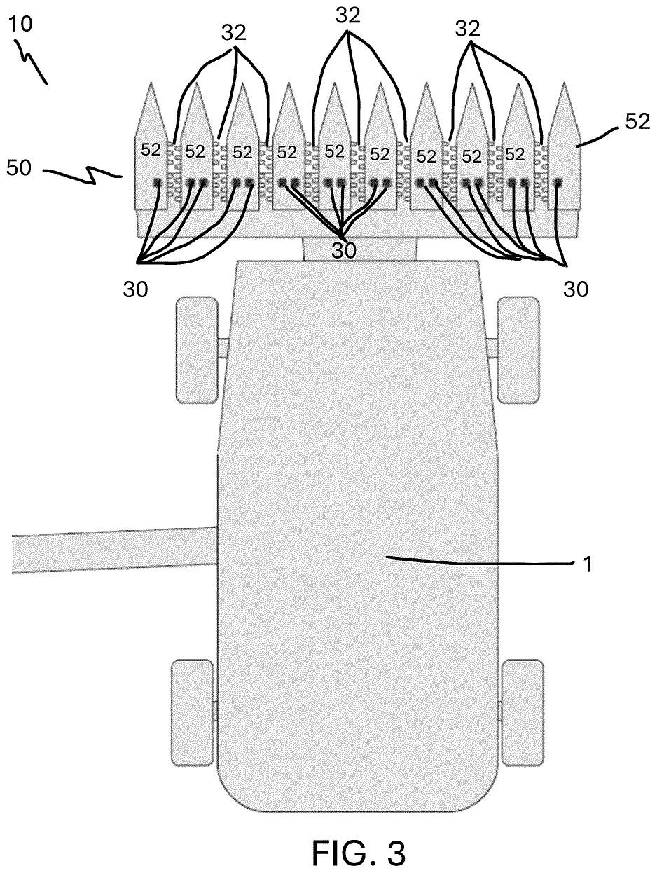

Turning now to FIGS. 3-5, in various implementations cameras 30 are placed on the harvester 1 to gather information regarding fruit during harvest. For example, cameras 30 on a corn head 50 are located and orientated such that the cameras 30 view at least the gathering chains 52/deck plates of the corn head 50. That is, the corn head 50 may include more than one camera 30, and optionally multiple cameras 30 per row, that together view all of the gathering chains 32/deck plates.

In various further implementations, cameras 30 may be orientated such that some of the cameras 30 view gathering chains 32/deck plates, while other cameras 30 are orientated such as to have a more vertical view, towards the tops of the plants and away from the head 50. These implementations may be used for plants that are tall, such as corn where the ear may be located above the head at a height where a camera oriented toward the gathering chains 32 would not capture the ear on the stalk.

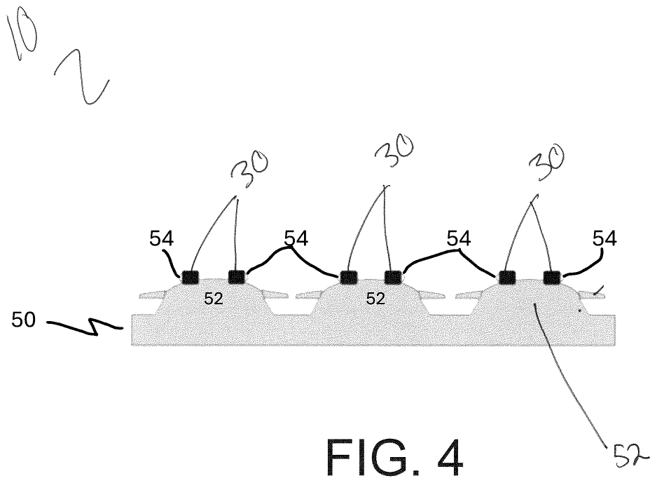

Optionally, the cameras 30 may be molded into the corn head 50 snoot 52 (i.e., integral with the snoot 52) or mounted on top of the snoot 52. When the camera(s) 30 are located on top of the snoot 52, as shown in FIG. 4, the camera 30 may be protected by shielding 54 to prevent the camera 30 and mounting enclosure from obstructing crop flow.

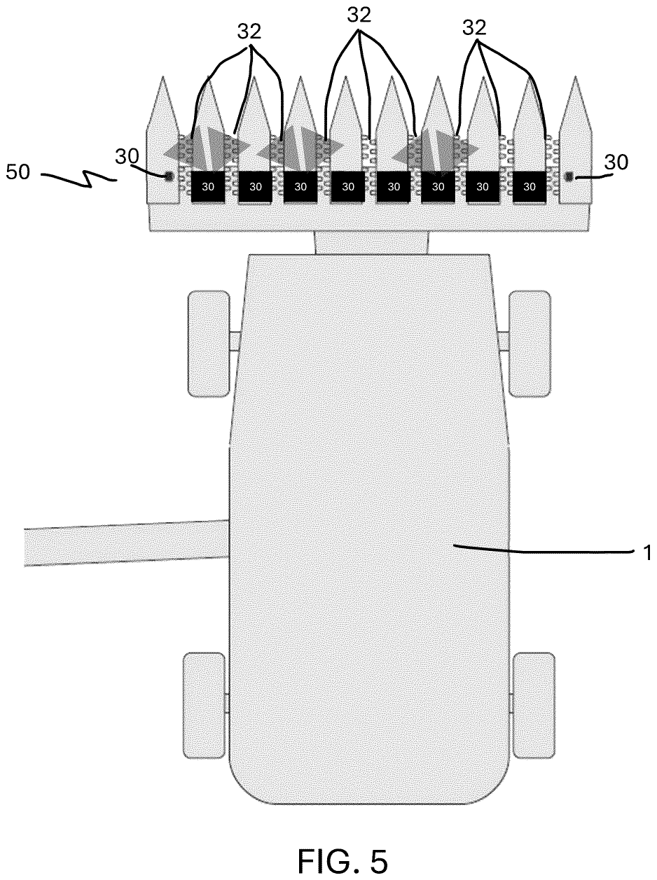

A further optional mounting location would be at a point on the head 50 where one camera 30 can view the gathering chains 52 on both sides of the snoot 52 simultaneously, shown for example in FIG. 5. In these implementations, the gathering chains 32 for one row are be viewed by two cameras 30, one on each side of the snoot 52 to gather further detail.

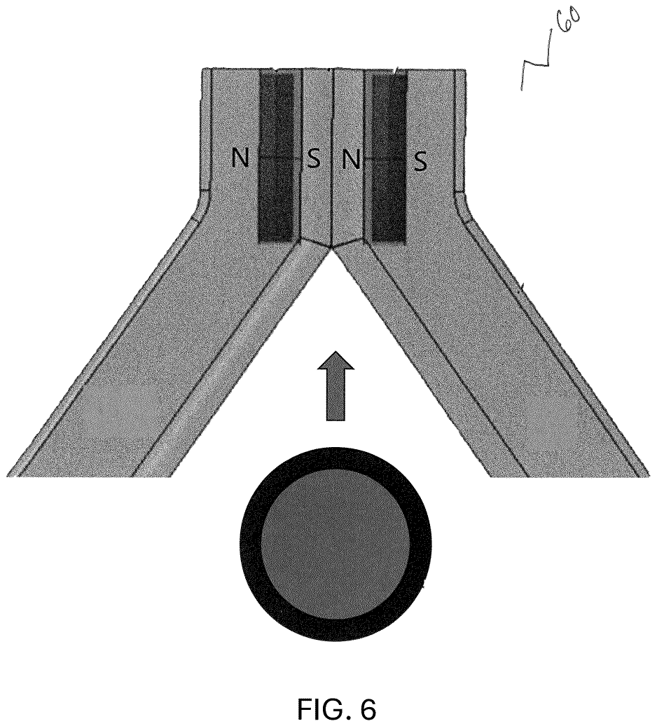

In various implementations, the system 10 may work in conjunction with a crop sensor 60 to sense stalks. An exemplary crop sensor 60 is shown in FIG. 6. Various exemplary crop sensors 60 are discussed in various of the incorporated references including: U.S. Pat. Nos. 11,064,653, 11,297,768, U.S. patent application Ser. No. 17/226,002, U.S. patent application Ser. No. 17/013,037, and U.S. patent application Ser. No. 18/087,413 among others.

Use of the system 10 having crop sensors 60 in addition to cameras 30 may produce additional resolution to a production problem the stakeholder might be having. In these and other implementations, the camera system 10 may identify ears that were present that are still enveloped in a cornhusk, and optionally yield per plant/row.

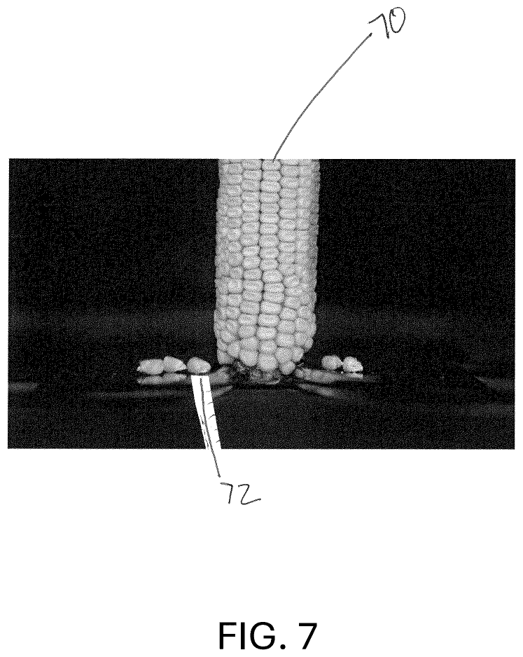

Turning to FIG. 7, in certain implementations, the system 10 may estimate loose kernels 72 that can occur when the settings on the corn head 50 are not set properly (shelled ear events), or if the ears are dryer than desired, which makes the ears more likely to loose kernels 72 when they are harvested, as would be generally understood. For example, if the system 10 detects that there are two kernels on the ground in a square foot, the system 10 may estimate one bushel of lost yield. In various implementations, the system 10 may detect a shelled ear event when the number of kernels visualized on the ground are more than a threshold number in a given area (i.e., more than two per square foot). In these and other implementations, the system 10 may alert the operator to excessive individual loose kernels 72 or shelled ear events, such that the operator or system 10 may automatically or semi-automatically take action before losing additional yield. For example, the corn head 50 height may be adjusted to prevent shelling, the gathering chains 32 speed may be adjusted, or other setting adjustments may be made.

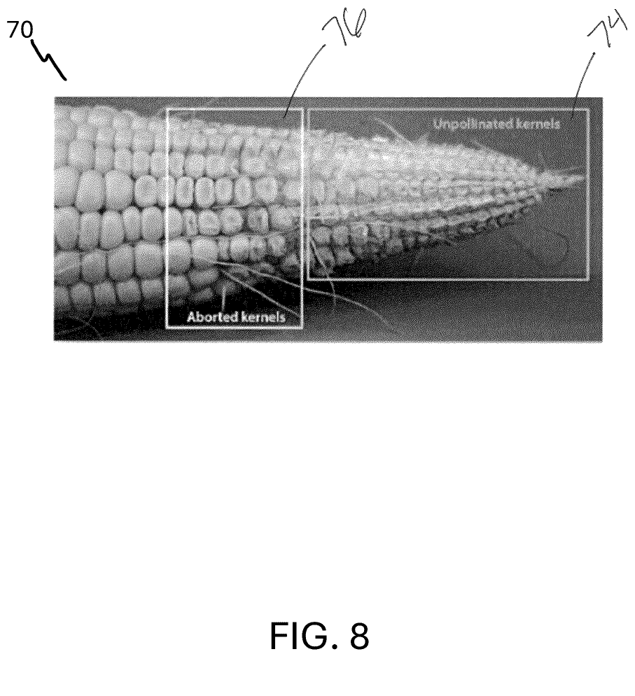

In further implementations, the system 10 may be able detect “tip back” or ears that were not pollinated during the growing season, an unpollinated ear 70 is shown for example in FIG. 8. For example, if the ears 70 that are harvested show a lot of small kernels 76 at the end of the ear, this indicates that the kernels were pollinated, but the plant ran out of nutrients and aborted at the end of the growing season and had to sacrifice the end kernels 74 to fill out the other kernels lower on the ear 70, shown in FIG. 8.

If tip back, unpollinated ears, or nutrient deficiencies are happening more frequently in certain areas of a field, but other more productive parts of a field have fully filled out ears, the system 10 and/or a grower may acknowledge that there are some changes that could be made to achieve higher yields and take action automatically or semi-automatically. For example, plant population may be reduced in future plantings, more fertilizer may be applied to help the plant hold on to more full kernels during the growing season, and other actions as would be understood and appreciated by those of skill in the art.

If the camera system 10 shows the ears of corn have tip back 74, and weather data indicates a dry season following the crop growth stage of pollination, this data may indicate to a user and/or the system 10 to adjust the seeding rate based on weather data or consider increasing the nitrogen and/or sulfur rates to help improve the crop health during the late growing season. As would be generally understood, nitrogen, sulfur, and potassium rates can affect the late season crop health as the plants can pull these nutrients from lower in the plant to maintain kernels position on the ear. If the kernel does not have enough moisture, (i.e. there is not enough moisture in the soil) there is less soil mineralization resulting in less foundational nutrient uptake, ultimately leading to kernel abortion.

If the cameras 30 show tip back 74, as well as aborted kernels 76, then the grower/system 10 may consider reducing plant population, as well as increasing applied nutrients in conditions amenable to application. If weather data confirms favorable weather conditions, but the system 10 indicates tip back 74 and aborted 76 kernels, then soil nutrient availability is likely the limiting factor in kernel growth and retention.

If the system 10 detects ears that have no evidence of pollination, this may indicate issues during pollination such as high temperatures and/or dry conditions. Cool temperatures and sufficient moisture will generally allow pollination of all ears to the tip of the cob and provide a better yield.

If the system 10 detects fully developed ears (no or minimal tip back and/or aborted kernels), the system 10 may automatically or semi-automatically output a recommendation or take action to increase the planting population.

Confirmatory data may also be used before recommending action, such as yield performance (yield per 1000 plants) being greater than or less than a threshold value (e.g., 8 bu/1k plants). Other confirmatory data examples include in-season remote sensing imagery showing healthy crop images and/or historical yield trend analysis, among others.

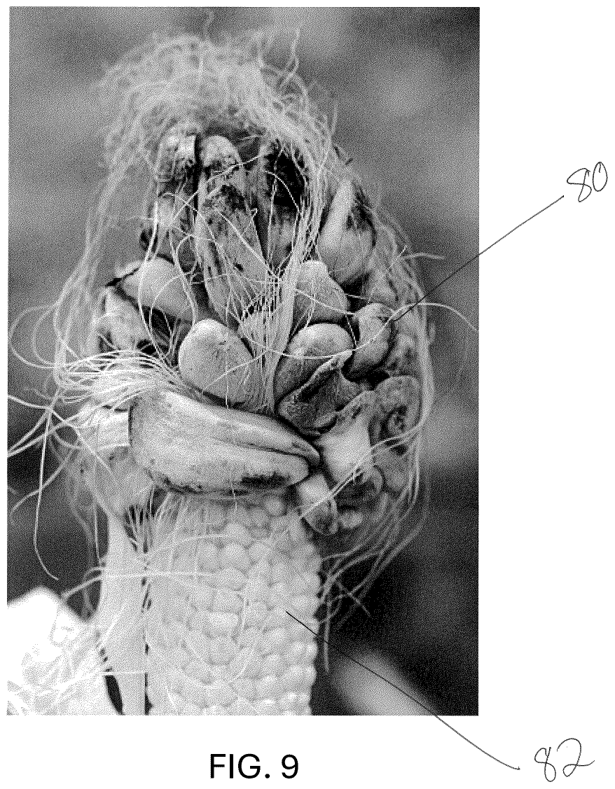

In some implementations, if the system 10 detects changes in grain quality, such as by assessing discolored areas or identifying damaged kernels 80 from healthy kernels 82, shown for example in FIG. 9. As would be appreciated, kernel fruit rows are homogenous in size and color in many genera of commercially grown corn; changes in color are likely to be indicative of disease or fungus. The system 10 may be programmed to trigger a warning or recommendation to a grower if more than a threshold amount (e.g., 10%) of the harvested fruit is discolored or misshapen. If the system 10 detects irregular changes in color and/or shape, the grower and/or system may automatically or semi-automatically recommend application of or apply fungicide or pesticide to maintain crop health throughout the year. Similarly, if the collected fruit is bruised from weather events, namely hail, the system 10 may be programmed to trigger a warning to the grower if more than a threshold amount (e.g., 10%) of the collected fruit is bruised following a recent weather event.

In various implementations, the system 10 can identify rows of kernels, and estimate the number of kernels on an ear, the number of unpollinated kernels/ears, number of aborted 76 kernels/ears having aborted kernels, number of damaged/diseased kernels/ears, etc.

For example, if the camera 30 is able to view a broad-side view of the ear, and can see 6-7 rows clearly, the system 10 may be programmed to assume that there is 16 to 18 rows of kernels on the ear of corn. The number of rows that are visible may vary depending on the amount of husk left on the ear and the girth of the ear that is in view.

In another example, where the system 10 may only be able to see 5 rows in the imagery, but the ear has 14 rows around, but because the top and bottom rows are hard to identify by the camera 30 the number may be underestimated. Various programs of the system 10 may be run to estimate and determine an approximate number of rows of kernels based on the knowledge of those of skill in the art and/or machine learning algorithms.

In some implementations, if ears are positioned correctly (i. e, such that a profile view of the side of the ear is shown), the system 10 may estimate the length of the ear and optionally count the number of kernels in each row of the ear. With this data, the system 10 may be able to estimate the number of kernels coming from each row of the corn head 50. In certain of these implementations, the system 10 can assess how many kernels are coming from each row, and therefore determine the rows that have better/worse yield than other rows and assign the proper yield to each row. Knowing the yield per row, and the number of stalks per row can help stakeholders (e.g., farmers and crop advisors) to better understand plant populations, and improve overall yield, as well as identify areas of the farm that may be improved such as by addressing planter singulation and/or seed depth. In various further implementations, the system 10 may provide recommendations and/or implement machine learning to provide recommendations for changes to planting, harvesting, and various other farming practices to improve overall yield. In further implementations, the system 10 may automatically apply recommendations or make changes that are indicated.

In various further implementations the system 10 may quantify the amount of weeds present during harvest. Knowledge and data about weed presence may improve the quality of stalk counts obtained from a stalk sensor 60, discussed above and in the incorporated references, to know the difference between a weed being counted by the sensor 60 versus a corn stalk were the signals from the sensor 60 look the same to the system 10.

Various further implementations of system 10 may be used in conjunction with other crops as well where the head loss is dependent on a proper mounting location of the camera 30 to measure the lost grain/fiber. For example, cotton, direct cut grain, and soybeans may all be possible with the right mounting location, and camera 30/system 10 training.

It would be appreciated that the system 10 may not capture all ears, but instead capture periodic ears throughout the field. In these and other implementations, the system 10 may identify if different regions of a field had more unpollinated ears, or more kernels that were aborted, versus another part of the field that had kernels filled out completely to the end of the ear and other comparisons as would be understood in light of this disclosure. In one example, the system 10 may maintain plant populations of seed corn in subsequent planting prescriptions in the areas with fully developed ears, and reduce the population of planted stand in the areas of the field with less pollinated kernels, aborted kernels, or other indicator of poor health.

Any of the above harvest health metrics can be stand alone observations, or can be used in combination with a stalk counting system, described variously in the incorporated references, where the number of plants that were harvested can be correlated with the number of ears that were harvested to further refine the actions for further planting or growing prescriptions or other actions to improve the crop yield for the grower.

In various implementations, the system 10 includes various software, hardware, and firmware components needed to execute the programs and methods of the system 10. Optionally, the system 10 may include a communications component configured to convey data from the cameras 30 to a tractor/display/cloud for further processing by the processor.

The display may optionally include a communications component configured to send and receive instructions for operation of the system 10, harvester 1, and components thereof. The display may also optionally include a graphical user interface (GUI), a memory/storage, a global positioning system (GPS), and other components necessary to effectuate the methods of the system.

Although the disclosure has been described with references to various embodiments, persons skilled in the art will recognize that changes may be made in form and detail without departing from the spirit and scope of this disclosure.

What is claimed is:

1. An agricultural harvester comprising:
(a) a plurality of row units divided by a plurality of snoots;
(b) at least one camera disposed on each of the plurality of snoots positioned such as to view gathering chains the plurality of row units; and
(c) a processor in communication with the at least one camera,
wherein the processor is configured to determine one or more of fruit production per stalk, fruit size, kernel number per ear, loose kernels, shelling events, and weed number.

2. The agricultural harvester of claim 1, wherein the at least one camera is integral with a respective one of the plurality of snoots.

3. The agricultural harvester of claim 1, further comprising at least one stalk sensor disposed on each of the plurality of row units configured to detect plant stalks, the at least one stalk sensor in communication with the processor, wherein the processor is configured to correlate imagery from the at least one camera with data from the at least one stalk sensor.

4. The agricultural harvester of claim 1, wherein the processor is configured to determine a number of kernels per ear based on imagery from the least one camera.

5. The agricultural harvester of claim 5, wherein the number of kernels per ear is based upon a detected number of rows on the ear and the length of kernels on the ear.

6. The agricultural harvester of claim 1, wherein the processor is configured to detect and determine a number of unpollinated kernels, aborted kernels, and normal kernels.

7. The agricultural harvester of claim 6, wherein the processor is configured to adjust a planting and growing prescription based on the detected a number of unpollinated kernels, aborted kernels, and normal kernels.

8. A harvesting system comprising:
(a) a plurality of cameras disposed on a corn head oriented to view gathering chains of the corn head row units and configured to gather imagery of plants during harvest operations; and
(b) a processor in communication with the plurality of cameras configured to analyze the gathered imagery.

9. The harvesting system of claim 8, wherein the processor is configured to detect a shelled ear event by estimating a number of loose kernels present and when the number of loose kernels exceeds a threshold value a shelled ear event is detect, and wherein the processor is configured to automatically adjust one or more header settings in response to a detected shelled ear event.

10. The harvesting system of claim 8, wherein the processor is configured to detect and enumerate a number of unpollinated ears, aborted kernels, and normal kernels harvested.

11. The harvesting system of claim 10, wherein if the number of unpollinated ears or aborted kernels exceeds a threshold value the processor may automatically adjust a planting prescription for a future planting to adjust a population to be planted or adjust an amount of fertilizer to be applied.

12. The harvesting system of claim 8, further comprising a memory in communication with the processor, the memory storing weather data from a growing season, and wherein the weather data may be analyzed along with the imagery to assess plant health.

13. The harvesting system of claim 8, wherein the plurality of cameras are integral with their respective snoot.

14. The harvesting system of claim 8, wherein the plurality of cameras are mounted on a first side of a plurality of snoots dividing a plurality of row units.

15. The harvesting system of claim 8, further comprising at least one stalk sensor disposed on each of the plurality of row units configured to detect plant stalks, the at least one stalk sensor in communication with the processor, wherein the processor is configured to correlate imagery from the plurality of cameras with data from the at least one stalk sensor.

16. A method for assessing harvest health comprising:
obtaining imagery from a plurality of cameras mounted on a corn head during harvest and orientated to view gathering chains of the corn head;
processing the imagery to detect one or more indicators of harvest health including one or more of number of ears harvested, shelled ear events, number of unpollinated ears, number of aborted kernels, number of kernels per ear, number of normal kernels, weed presence, and disease presence; and
outputting one or more recommendations or actions for modifying a planting prescription to improve yield based on the detected indicators of harvest health.

17. The method of claim 16, further comprising detecting a shelled ear event by estimating a number of loose kernels present and when the number of loose kernels exceeds a threshold value a shelled ear event is detected, and adjusting one or more header settings in response to a detected shelled ear event.

18. The method of claim 16, wherein the one or more recommendations or actions is adjusting a planting prescription for a future planting to adjust a population to be planted or adjust an amount of fertilizer to be applied

19. The method of claim 16, further comprising sensing plant stalks with a crop sensor mounted on a row unit of the corn head.

20. The method of claim 16, wherein the plurality of cameras are mounted on snoots of the corn head.
